(19) United States
(12) Patent Application Publication
(10) Pub. No.: US 2010/0275408 A1
(43) Pub. Date: Nov. 4, 2010

(54) Sliding Mechanism

(76) Inventors: San-Lang Ding, Taichung City (TW); Chun-Hui Chang, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/432,595

(22) Filed: Apr. 29, 2009

(51) Int. Cl. E05D 15/06

(52) U.S. Cl. 16/91

(57) ABSTRACT

A sliding mechanism includes a hollow track and a trolley. The hollow track includes a slot. The trolley includes a first plate, a second plate and rolling units. The first plate is wider than the slot and located in the hollow track, and includes two pairs of apertures. The second plate includes two pairs of apertures, and is mounted on the hollow track. Each rolling unit includes a trough, a cover and rollers. The cover is connected to the trough through a related pair of apertures so that they together form a pod. The rollers are disposed in the pod so that some of the rollers contact a side of a related one of the plates while some other rollers contact another side of the plate and that the rollers can roll and move in the pod through the apertures. A fastener fastens the plates to each other.

### BACKGROUND OF INVENTION

1. Field of Invention

The present invention relates to a sliding mechanism and, more particularly, to a smooth sliding mechanism without having to include a screw or bearings.

2. Related Prior Art

There is a sliding mechanism including a hollow track and a trolley movable in the hollow track. A board or canopy can be connected to the trolley so that the board or canopy can be smoothly moved between an extended position for carrying or shielding things and a withdrawn position for easy storage.

Such a sliding mechanism generally includes a screw or bearings in addition to the hollow track and the trolley. The length of the screw must be made about the length of the hollow track, and it is therefore troublesome to make the parts and put the parts together. On the other hand, the bearings can easily be used in the sliding mechanism. A bearing includes rollers or balls, and the entire bearing has to be replaced with another bearing even though only one of the rollers or balls fails. Hence, the cost is high.

The present invention is therefore intended to obviate or at least alleviate the problems encountered in prior art.

### SUMMARY OF INVENTION

It is the primary objective of the present invention to provide an easily made and inexpensive sliding mechanism.

According to the present invention, the sliding mechanism includes a hollow track and a trolley. The hollow track includes a slot defined therein. The trolley includes a first plate, a second plate and rolling units. The first plate is made with a width larger than that of the slot and two pairs of apertures and located in the hollow track. The second plate is made with two pairs of apertures and mounted on the hollow track. Each of the rolling units includes a trough, a cover and rollers. The cover is connected to the trough through a related one of the pairs of apertures of the first and second plates so that the cover and the trough together form a pod. The rollers are disposed in the pod so that some of the rollers are in contact with a side of a related one of the first and second plates while some other rollers are in contact with another side of the plate and that the rollers can roll and move in the pod through the apertures. A fastener fastens the first and second plates to each other.

Other objectives, advantages and features of the present invention will become apparent from the following description referring to the attached drawings.

### BRIEF DESCRIPTION OF DRAWINGS

The present invention will be described via detailed illustration of several embodiments referring to the drawings.

FIG. 1 is a perspective view of a sliding mechanism according to the first embodiment of the present invention.

FIG. 2 is an exploded view of the sliding mechanism shown in FIG. 1.

FIG. 3 is a cross-sectional view of the sliding mechanism shown in FIG. 1.

FIG. 4 is another cross-sectional view of the sliding mechanism shown in FIG. 1.

FIG. 5 is a perspective view of a sliding mechanism according to the second embodiment of the present invention.

FIG. 6 is an exploded view of the sliding mechanism shown in FIG. 5.

FIG. 7 is a cross-sectional view of the sliding mechanism shown in FIG. 5.

FIG. 8 is another cross-sectional view of the sliding mechanism shown in FIG. 5.

FIG. 9 is a perspective view of a sliding mechanism according to the third embodiment of the present invention.

FIG. 10 is a perspective view of a sliding mechanism according to the fourth embodiment of the present invention.

FIG. 11 is an exploded view of a sliding mechanism according to the fifth embodiment of the present invention.

FIG. 12 is a cross-sectional view of the sliding mechanism shown in FIG. 11.

FIG. 13 is another cross-sectional view of the sliding mechanism shown in FIG. 11.

FIG. 14 is a cross-sectional view of a sliding mechanism according to the sixth embodiment of the present invention.

FIG. 15 is a cross-sectional view of a sliding mechanism according to the seventh embodiment of the present invention.

FIG. 16 is a cross-sectional view of a sliding mechanism according to the eighth embodiment of the present invention.

### DETAILED DESCRIPTION OF EMBODIMENTS

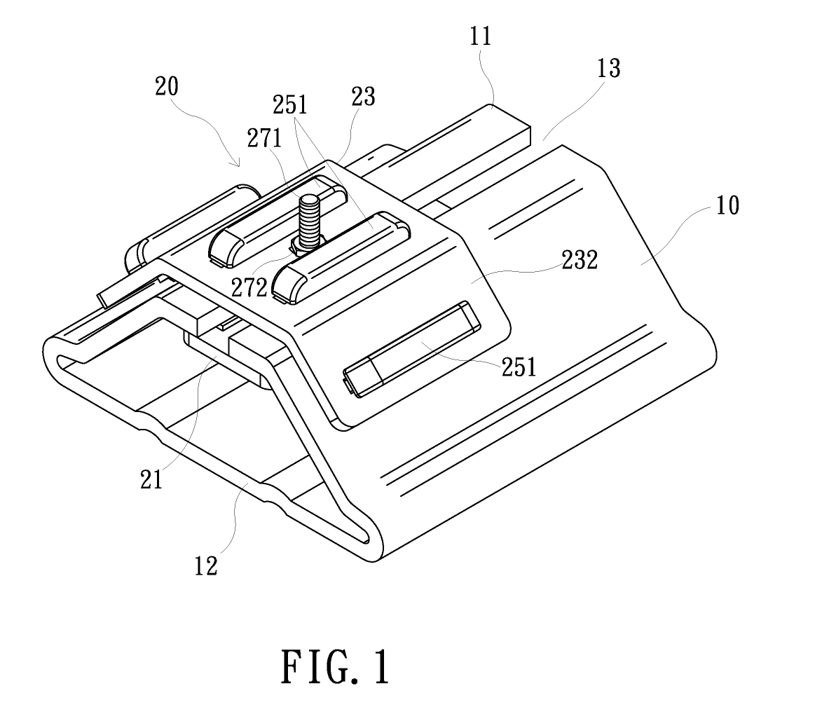

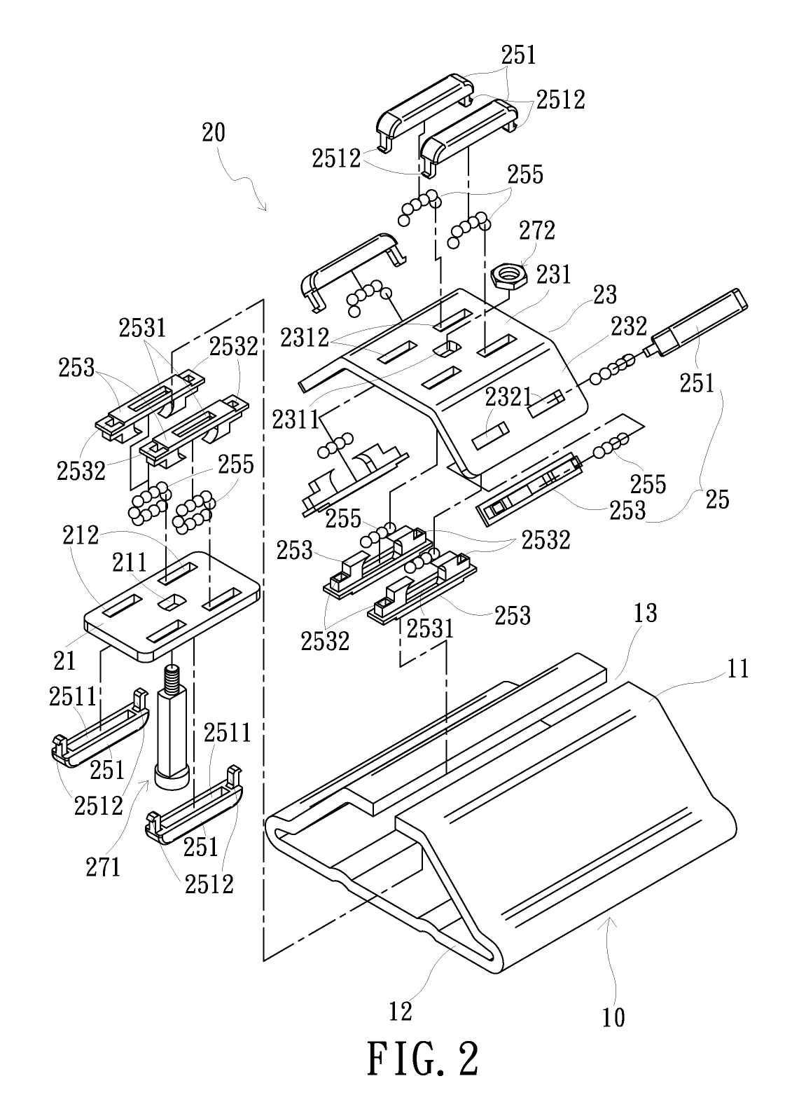

Referring to FIGS. 1 to 4, a sliding mechanism includes a track 10 and a trolley 20 according to a first embodiment of the present invention. The track 10 is made with a hollow configuration including a top 11 formed on a base 12. The top 11 includes a slot 13 defined therein.

The trolley 20 includes a first plate 21, a second plate 23 and rolling units 25. The width of the first plate 21 is larger than that of the slot 13. The first plate 21 includes an aperture 211 and two pairs of slots 212. The aperture 211 is located between the pairs of slots 212. The pairs of slots 212 are parallel to each other.

The second plate 23 includes a central portion 231 corresponding to the first plate 21 and two lateral portions 232 extended from the central portion 231. The central portion 231 of the second plate 23 includes an aperture 2311 and two pairs of slots 2312. The aperture 2311 is located between the pairs of slots 2312. The pairs of slots 2312 are parallel to each other. Each of the lateral portions 232 of the second plate 23 includes a pair of slots 2321 defined therein.

Each of the rolling units 25 includes rollers 255 contained in a pod that includes a trough 251 and a cover 253. The rollers 255 are in the form of balls. The trough 251 includes a groove 2511 defined in a side and two hooks 2512 extended from the side. The cover 253 includes a slot 2531 defined in a side and two lugs 2532 formed at two ends thereof.

Four of the rolling units 25 are connected to the first plate 21. For each of these rolling units 25, some of the rollers 255 are disposed in the groove 2511 of the trough 251. Some other rollers 255 are disposed in the slot 2531 of the cover 253. Another roller 255 is disposed in one of the slots 212 of each pair while the other roller 255 is disposed in the other slot 212 of the pair. The hooks 2512 of the trough 251 are inserted through the slots 212 and engaged with the lugs 2532. Thus, the rollers 255 can roll and move in a loop defined by the first plate 21 and the pod.

The other rolling units 25 are connected to the first plate 21. For each of these rolling units 25, some of the rollers 255 are disposed in the groove 2511 of the trough 251. Some other rollers 255 are disposed in the slot 2531 of the cover 253. Another roller 255 is disposed in one of the slots 2312 or 2321 of each pair while the other roller 255 is disposed in the other slot 2312 or 2321 of the pair. The hooks 2512 of the trough 251 are inserted through the slots 2312 or 2321 and engaged with the lugs 2532. Thus, the rollers 255 can roll and move in a loop defined by the second plate 23 and the pod.

A threaded bolt 271 is inserted through the aperture 211 of the first plate 21 and the aperture 2311 of the second plate 23. A nut 272 is engaged with the threaded bolt 271. Thus, the trolley 20 is assembled and movably mounted on the track 10.

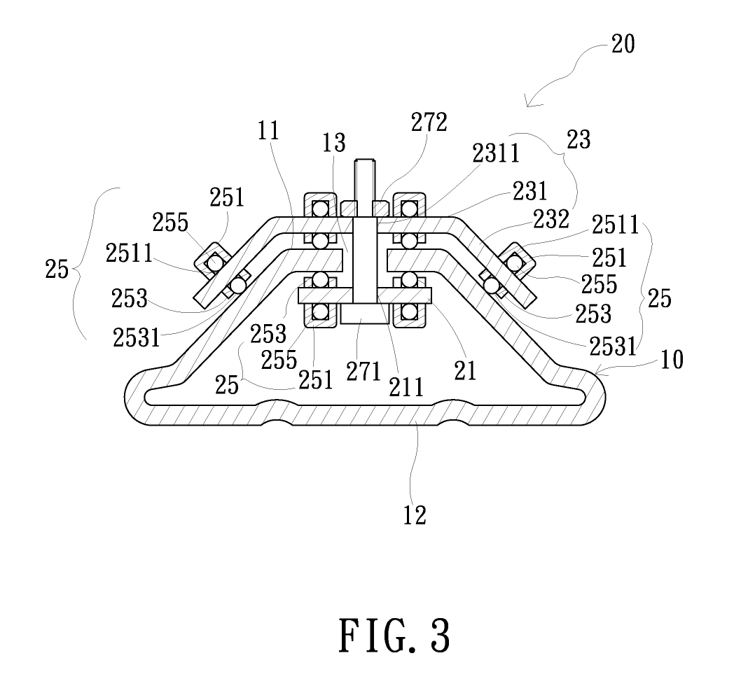

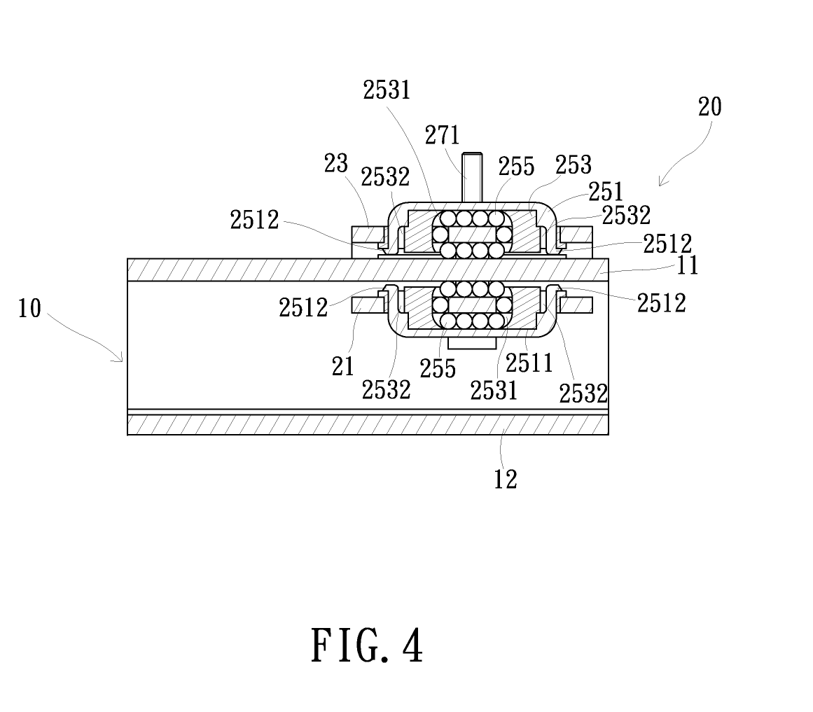

As clearly shown in FIGS. 3 and 4, some of the rollers 255 are in contact with a lower side of the top 11 of the track 10 while the other rollers 255 are in contact with an upper side of the top 11 of the track 10. The total area of contact of the rollers 255 with the top 11 of the track 10 is small. Furthermore, the total area of contact of the rollers 255 with one another is small so that the rollers 255 can easily roll against one another. Hence, the rollers 255 roll, not slide, on the track 10. Hence, friction between the trolley 20 and the track 10 is small when the former moves on the latter. That is, the trolley 20 can move smoothly on the track 10.

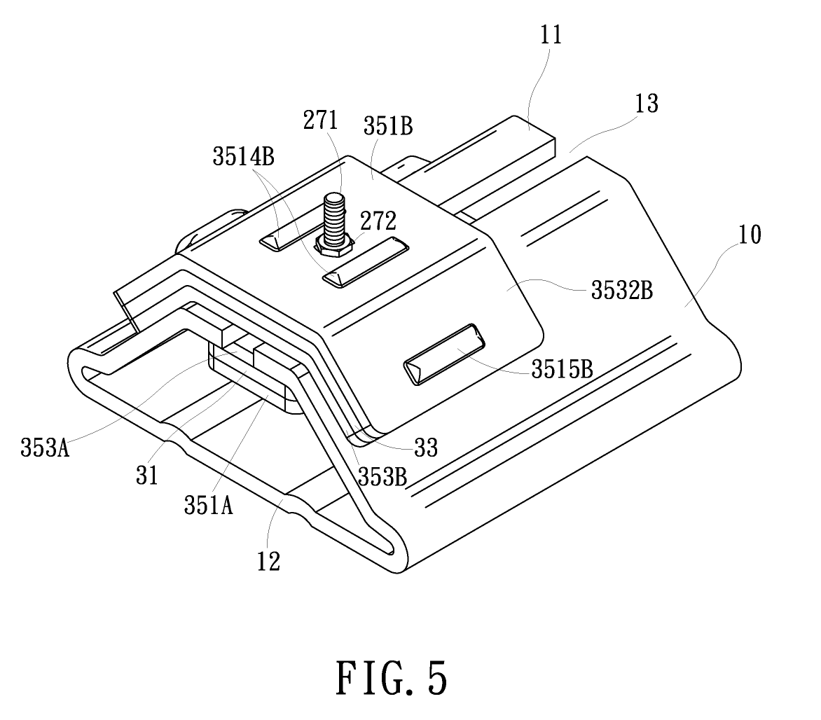

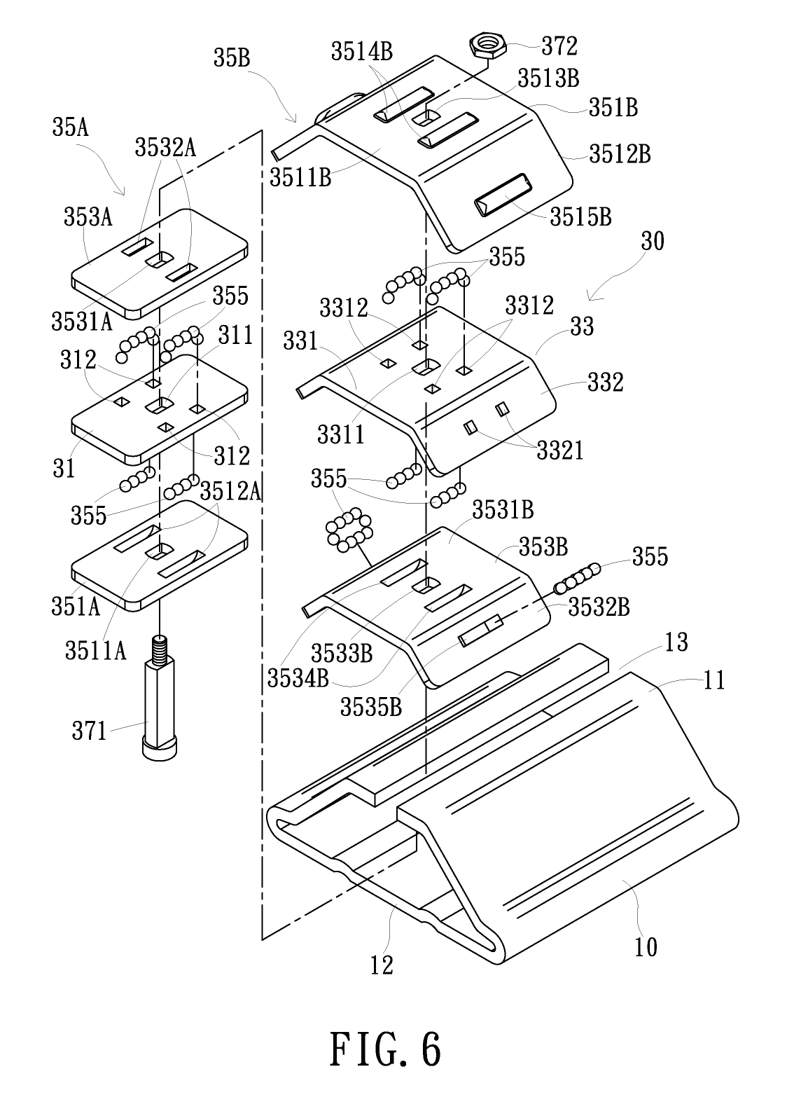

Referring to FIGS. 5 through 8, a sliding mechanism includes a hollow track 10 and at least one trolley 30 according to a second embodiment of the present invention. The trolley 30 includes a first plate 31, a second plate 33, a first rolling unit 35A and a second rolling unit 35B. The first plate 31 includes a central aperture 311 and two pairs of lateral apertures 312. The pairs of lateral apertures 312 are parallel to each other.

The first rolling unit 35A includes rollers 355, a trough 351A and a cover 353A. The rollers 355 are in the form of balls. The trough 351A includes an aperture 3511A defined therein and two grooves 3512A defined in a side thereof. The cover 353A includes an aperture 3531A defined therein and two slots 3532A defined therein so that the aperture 3531A is located between the slots 3532A.

Some of the rollers 355 are disposed in the grooves 3512A of the trough 351A. Some other rollers 355 are disposed in the slots 3532A of the cover 353A. The other rollers 355 are disposed in the pairs of apertures 312 of the first plate 31.

The second plate 33 includes a central portion 331 corresponding to the first plate 31 and two lateral portions 332 extended from the central portion 331. The central portion 331 of the second plate 33 includes a central aperture 3311 and two pairs of lateral apertures 3312. The central aperture 3311 is located between the pairs. The pairs are parallel to each other. Each of the lateral portions 332 of the second plate 33 includes a pair of apertures 3321.

The second rolling unit 35B includes rollers 355, a trough 351B and a cover 353B. The rollers 355 are in the form of balls. The trough 351B includes a central portion 3511B and two lateral portions 3512B extended from the central portion 3511B. The central portion 3511B of the trough 351B includes an aperture 3513B defined therein and two grooves 3514B defined in a side thereof by punching. Each of the lateral portions 3512B of the trough 351B includes a groove 3515B defined in a side thereof. The cover 353B includes a central portion 3531B and two lateral portions 3532B extended from the central portion 3531B. The central portion 3531B of the cover 353B includes an aperture 3533B defined therein and two slots 3534B defined therein. Each of the lateral portions 3532B of the cover 353B includes a slot 3535B defined therein.

Some of the rollers 355 are disposed in the grooves 3514B and 3515B of the trough 351B. Some other rollers 355 are disposed in the slots 3534B and 3535B of the cover 353B. The other rollers 355 are disposed in the pairs of lateral apertures 3312 and 3321 of the second plate 33.

A threaded bolt 371 is inserted through the apertures 3511A, 311, 3531A, 3533B, 3311 and 3513B. A nut 372 is engaged with the threaded bolt 371. Thus, the trolley 30 is assembled and movably mounted on the track 10.

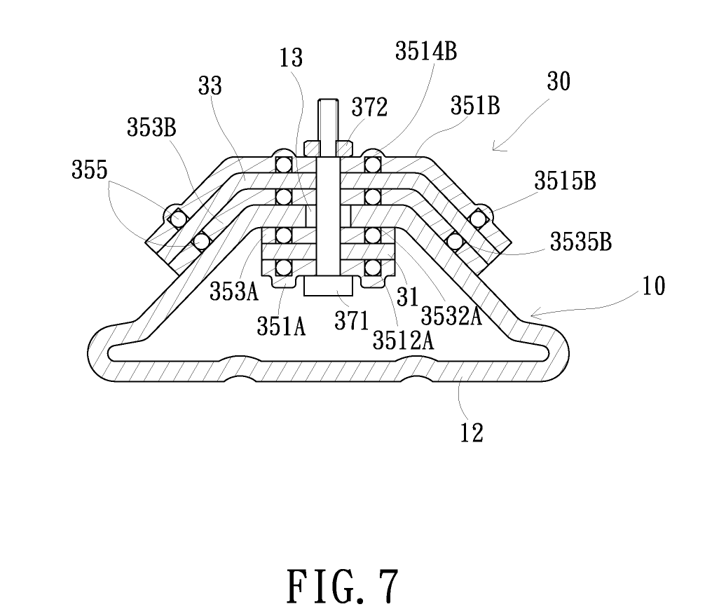

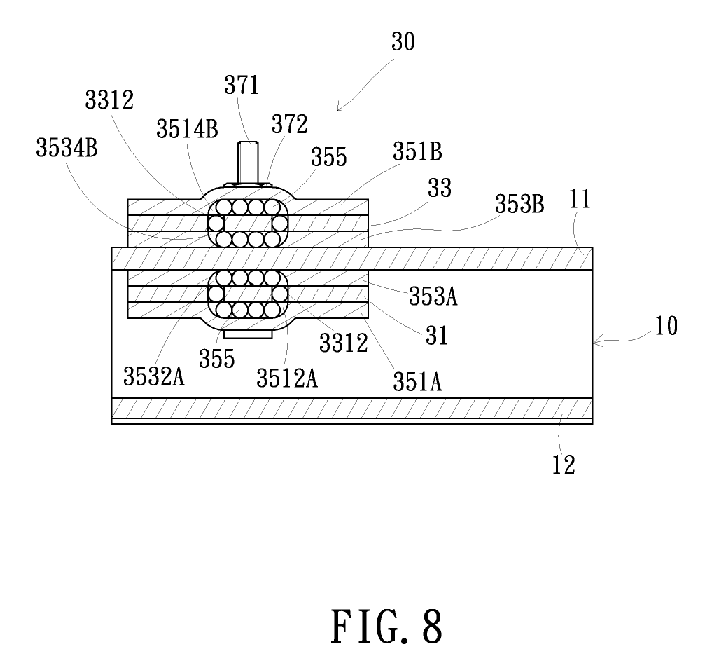

As clearly shown in FIGS. 7 and 8, some of the rollers 355 are in contact with a lower side of the top 11 of the track 10 while the other rollers 355 are in contact with an upper side of the top 11 of the track 10. The total area of contact of the rollers 355 with the top 11 of the track 10 is small. Furthermore, the total area of contact of the rollers 355 with one another is small so that the rollers 355 can easily roll against one another. Hence, the rollers 355 roll, not slide, on the track 10. Hence, friction between the trolley 30 and the track 10 is small when the former moves on the latter. That is, the trolley 30 can move smoothly on the track 10.

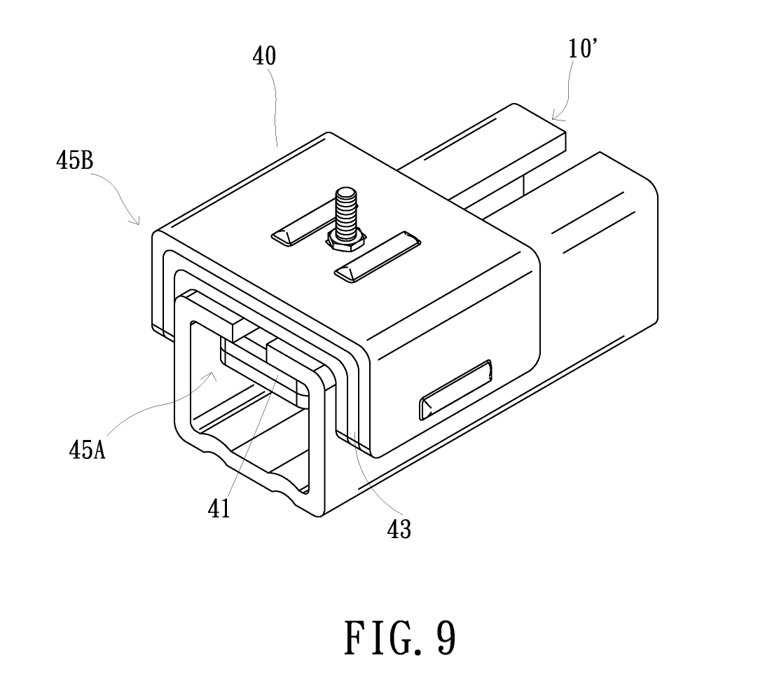

Referring to FIG. 9, there is shown a sliding mechanism according to a third embodiment of the present invention. The third embodiment is like the second embodiment except including a track 10′, plates 41 and 43 and rolling units 45A and 45B instead of the track 10, the plates 31 and 33 and the rolling units 35A and 35B, respectively. The track 10′ is like the track 10 but made with a different shape. The plate 41 is identical to the plate 31. The plate 43 is like the plate 33 but made with a different shape. The rolling unit 45A is like the rolling unit 35A but made with a different shape. The rolling unit 45B is like the rolling unit 35B but made with a different shape.

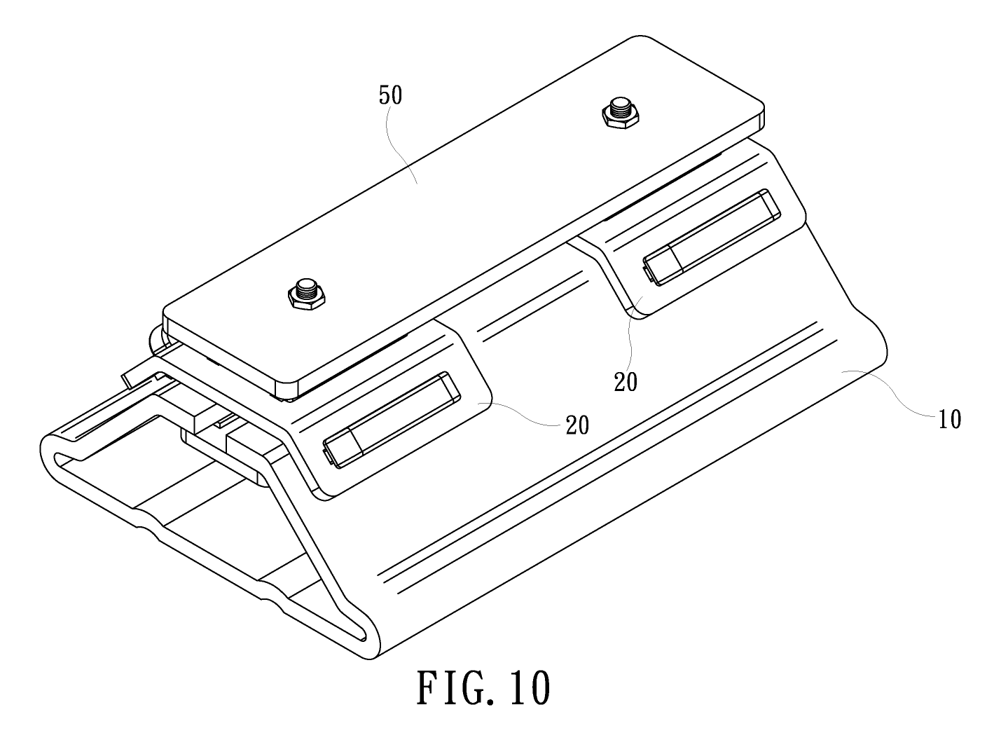

Referring to FIG. 10, there is shown a sliding mechanism according to a fourth embodiment of the present invention. The fourth embodiment is like the first embodiment except using two trolleys 20 and a board 50 supported on the trolleys 20.

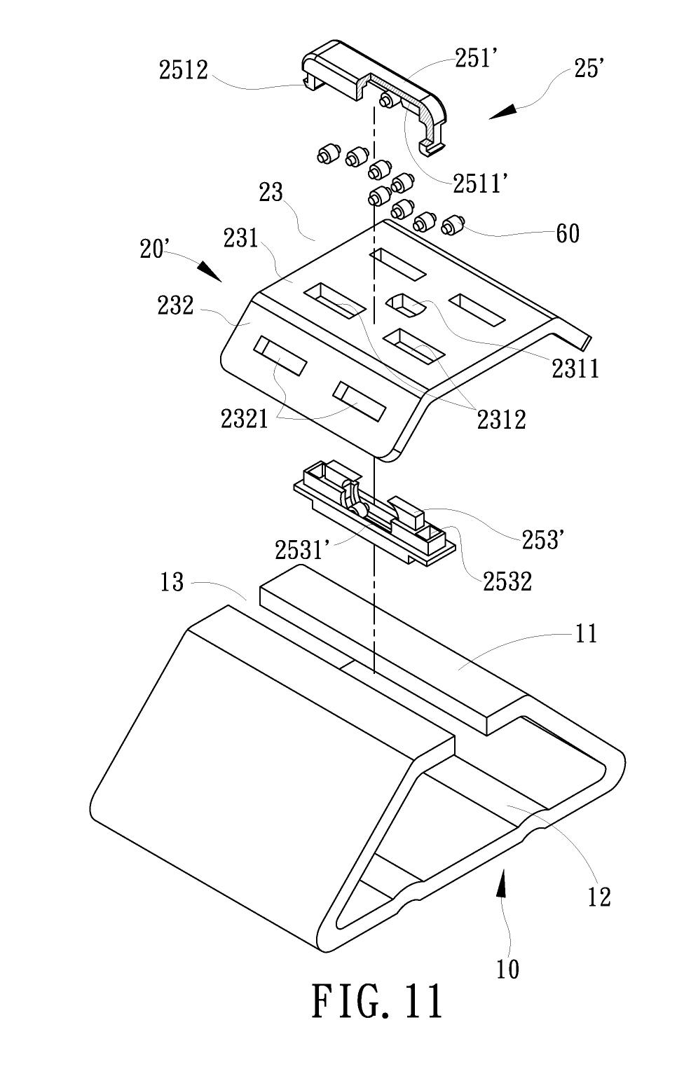

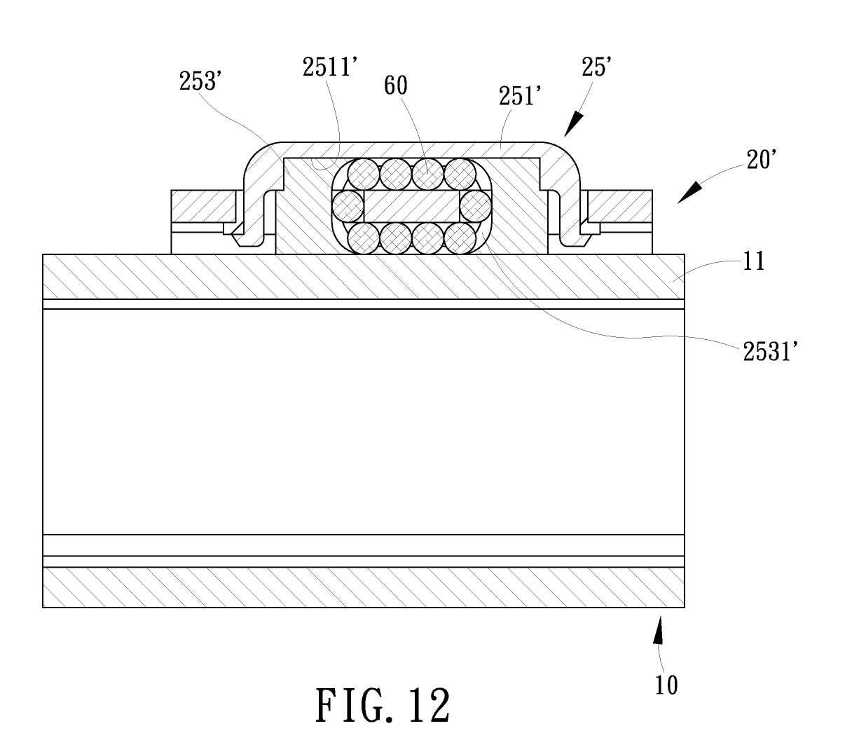

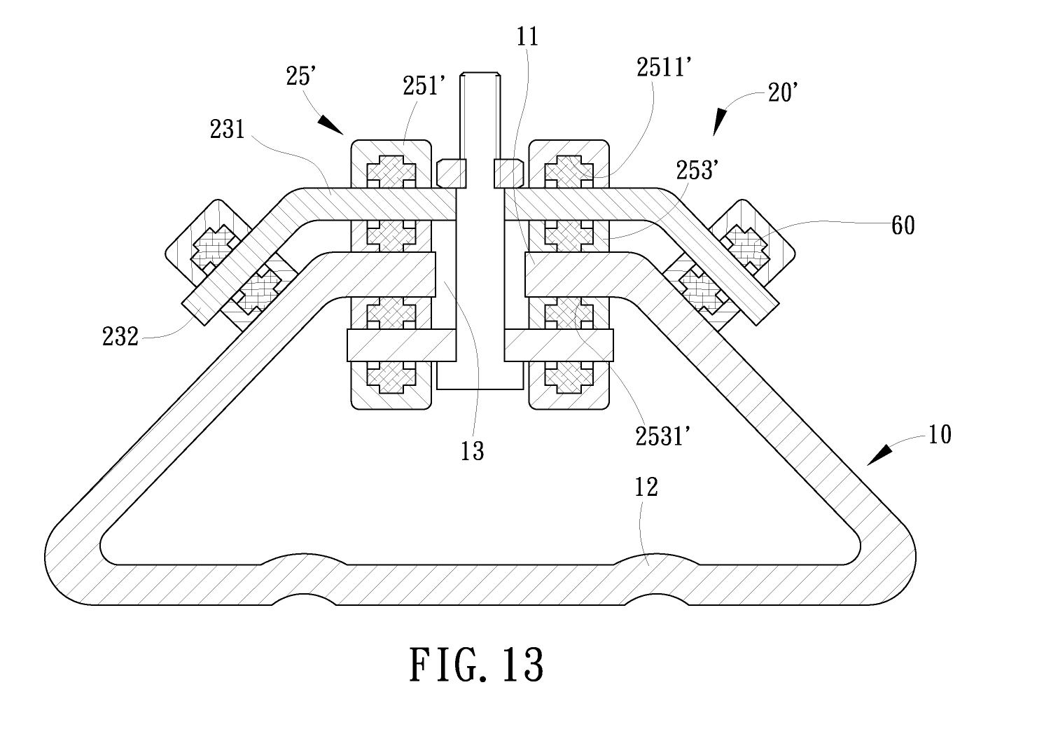

Referring to FIGS. 11 through 13, there is shown a sliding mechanism according to a fifth embodiment of the present invention. The fifth embodiment is like the first embodiment except including a trolley 20′ instead of the trolley 20. The trolley 20′ is like the trolley 20 except including rollers 60, troughs 251′ and covers 253′ instead of the rollers 255, the troughs 251 and the covers 253, respectively. Each of the rollers 60 includes a central portion 231 and two reduced lateral portions 232 extending from the central portion 231. Each of the troughs 251′ includes a groove 2511′ with a recessed floor corresponding to the profile of the rollers 60. Each of the covers 253′ includes a slot 2531′ with a cross-sectional shape corresponding to the profile of the rollers 60. The central portions of the rollers 60 contact the top 11 of the track 10.

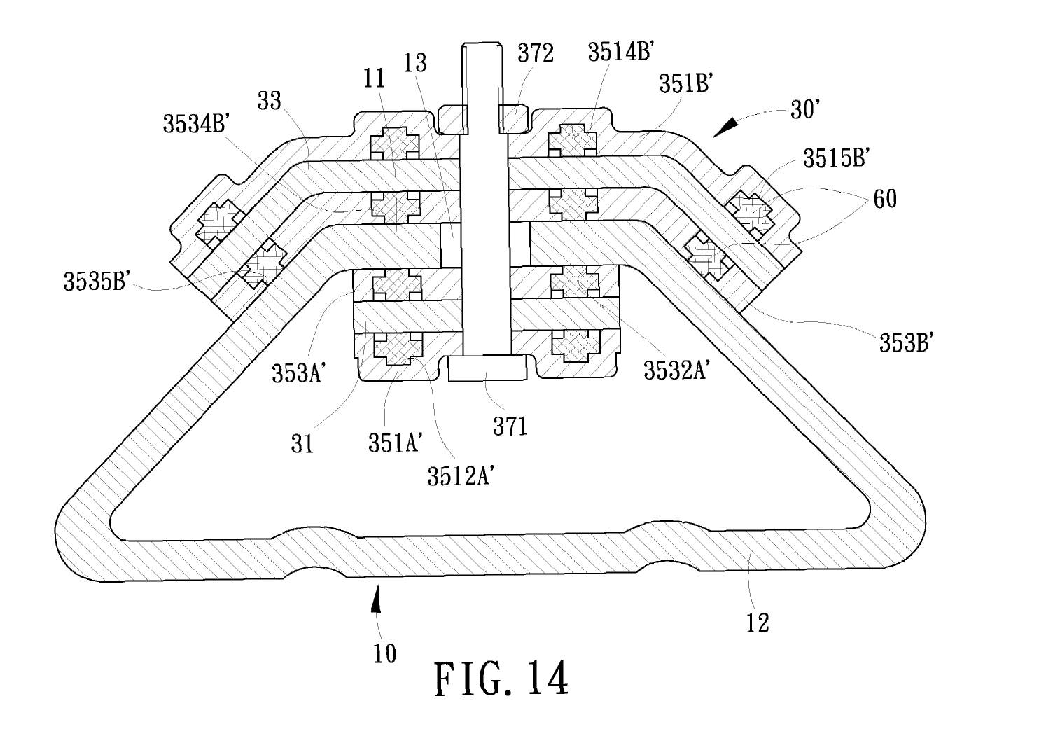

Referring to FIG. 14, there is shown a sliding mechanism according to a sixth embodiment of the present invention. The sixth embodiment is like the second embodiment except including rollers 60 instead of the rollers 255 and including troughs 35A′ and 351B′ and covers 353A′ and 353B′ instead of the troughs 351A and 351B and covers 353A and 353B, respectively. The trough 351A′ includes two grooves 3512A′ each including a recessed floor corresponding to the profile of the rollers 60. The trough 351B′ includes grooves 3514B′ and 3515B′ each including a recessed floor corresponding to the profile of the rollers 60. The cover 353A′ includes two slots 3532A′ each including a cross-sectional shape corresponding to the profile of the rollers 60. The cover 353B′ includes slots 3534B′ and 3535B′ each including a cross-sectional shape corresponding to the profile of the rollers 60. The central portions of the rollers 60 are in contact with the top 11 of the track 10.

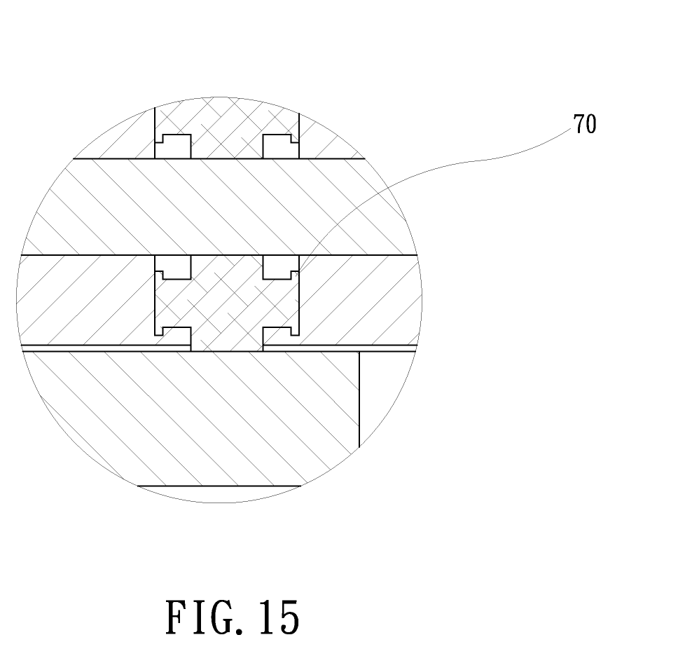

Referring to FIG. 15, there is shown a sliding mechanism according to a seventh embodiment of the present invention. The seventh embodiment is like the sixth embodiment except including rollers 70 instead of the rollers 60. The rollers 70 are like the rollers 60 except each including a wheel-shaped portion, two axle-shaped portions extended from the wheel-shaped portion and two disc-shaped portions extended from the axle-shaped portions. The diameter of the wheel-shaped portion is larger than that of the disc-shaped portions. The diameter of the disc-shaped portions is larger than that of the axle-shaped portions.

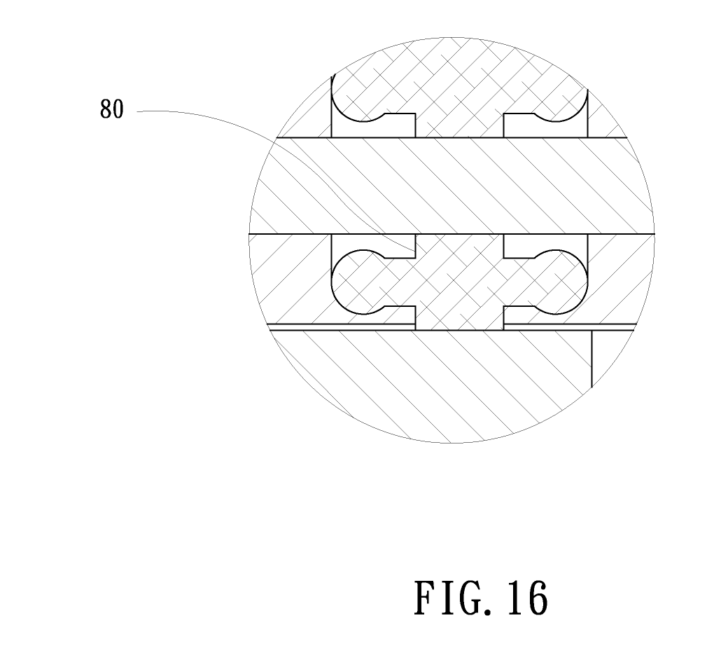

Referring to FIG. 16, a sliding mechanism according to an eighth embodiment of the present invention is shown. The eighth embodiment is like the sixth embodiment except including rollers 80 instead of the rollers 60. The rollers 80 are like the rollers 60 except each including a wheel-shaped portion, two axle-shaped portions extended from the wheel-shaped portion and two ball-shaped portions extended from the axle-shaped portions. The diameter of the wheel-shaped portion is larger than that of the ball-shaped portions. The diameter of the ball-shaped portions is larger than that of the axle-shaped portions.

As discussed, if any of the rollers fails, it can easily be replaced with a new roller. There is no need to replace an entire rolling unit with another rolling unit. The cost of using the sliding mechanism is low.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A sliding mechanism comprising:
a hollow track comprising a slot defined therein;
a trolley comprising:
a first plate made with a width larger than that of the slot and two pairs of apertures and located in the hollow track;
a second plate made with two pairs of apertures and mounted on the hollow track;
two rolling units each comprising:
a trough;
a cover connected to the trough through a related one of the pairs of apertures of the first and second plates so that a loop is defined by the trough, the cover and a related one of the first and second plates; and
rollers disposed in the loop so that some of the rollers are in contact with a side of a related one of the first and second plates while some other rollers are in contact with another side of the plate and that the rollers can roll and move in the loop; and
a fastener for fastening the first and second plates to each other.

2. The sliding mechanism according to claim 1, wherein the trough comprises two grooves for receiving the rollers, and the cover comprises two slots for exposing the rollers to the hollow track.

3. The sliding mechanism according to claim 1, wherein each of the first and second plates comprises a central aperture for receiving the fastener.

4. The sliding mechanism according to claim 1, wherein the rollers are in the form of a ball.

5. The sliding mechanism according to claim 1, wherein the rollers are in the form of a cylinder.

6. A sliding mechanism comprising:
a hollow track comprising a slot defined therein;
a trolley comprising:
a first plate made with a width larger than that of the slot and two pairs of apertures and located in the hollow track;
a second plate made with two pairs of apertures and mounted on the hollow track;
rolling units each comprising:
a trough;
a cover connected to the trough through a related one of the pairs of apertures of the first and second plates so that the cover and the trough together form a pod; and
rollers disposed in the pod so that some of the rollers are in contact with a side of a related one of the first and second plates while some other rollers are in contact with another side of the plate and that the rollers can roll and move in the pod through the apertures; and
a fastener for fastening the first and second plates to each other.

7. The sliding mechanism according to claim 6, wherein the trough comprises a groove for receiving the rollers and two hooks formed thereon, and the cover comprises a slot for exposing the rollers to the hollow track and two lugs engaged with the hooks.

8. The sliding mechanism according to claim 6, wherein each of the first and second plates comprises a central aperture for receiving the fastener.

9. The sliding mechanism according to claim 6, wherein the rollers are in the form of a ball.

10. The sliding mechanism according to claim 6, wherein the rollers are in the form of a cylinder.
